(19) United States
(12) Patent Application Publication
(10) Pub. No.: US 2018/0205802 A1
(43) Pub. Date: Jul. 19, 2018

(54) Cache Aware Streaming

(71) Applicant: Cisco Technology, Inc., San Jose, CA (US)

(72) Inventor: Gareth John Bowen, Southampton (GB)

(73) Assignee: Cisco Technology, Inc., San Jose, CA (US)

(21) Appl. No.: 15/405,348

(22) Filed: Jan. 13, 2017

(51) Int. Cl. H04L 29/08; H04L 12/26; H04L 29/06

(52) U.S. Cl. CPC H04L 67/2842; H04L 67/02; H04L 65/601; H04L 65/607; H04L 65/80; H04L 43/08

(57) ABSTRACT

Cache aware streaming may be provided. First, a client device may measure a transfer rate of a flow corresponding to content. The client device may then throttle down the flow to a first encode quality level in response to determining that the measured transfer rate of the flow will not support a current encode quality level of the flow. The first encode quality level may be lower than the current encode quality level. Next, the client device may determine a recommended encode quality level from a response corresponding to the flow. The flow may then be throttled up to the recommended encode quality level by the client device.

### TECHNICAL FIELD

The present disclosure relates generally to data streaming.

### BACKGROUND

Adaptive bitrate (ABR) streaming is a method of video streaming over Hypertext Transfer Protocol (HTTP) where the source content is encoded at multiple bit rates, then each of the different bit rate streams are segmented into small multi-second parts. The streaming client is made aware of the available streams at differing bit rates, and segments of the streams by a manifest file. When starting, the client requests the segments from the lowest bit rate stream. If the client finds the download speed is greater than the bit rate of the segment downloaded, then it may request the next higher bit rate segments. Later, if the client finds the download speed for a segment is lower than the bit rate for the segment, and therefore the network throughput has deteriorated, then it may request a lower bit rate segment. The segment size can vary depending on the particular implementation, but they are typically between two and ten seconds.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of a system for providing cache aware streaming;

FIG. 2 is a block diagram of a system for providing cache aware streaming;

FIG. 3 is a block diagram of a system for providing cache aware streaming;

FIG. 4 is a block diagram of a system for providing cache aware streaming;

FIG. 5 is a block diagram of a system for providing cache aware streaming;

FIG. 6 is a flow chart of a method for providing cache aware streaming;

FIG. 7 is a flow chart of a method for providing cache aware streaming;

FIG. 8 is a flow chart of a method for providing cache aware streaming; and

FIG. 9 is a block diagram of a computing device.

### DETAILED DESCRIPTION

### Overview

Cache aware streaming may be provided. First, a client device may measure a transfer rate of a flow corresponding to content. The client device may then throttle down the flow to a first encode quality level in response to determining that the measured transfer rate of the flow will not support a current encode quality level of the flow. The first encode quality level may be lower than the current encode quality level. Next, the client device may determine a recommended encode quality level from a response corresponding to the flow. The flow may then be throttled up to the recommended encode quality level by the client device.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

ABR delivery may rely on HTTP as a transport for media data (e.g., content) and may attempt to leverage the benefits of HTTP (e.g., caching). A client device may be responsible for requesting content and measuring throughput (i.e., transfer rates/latency) for the content. The client may adapt its choices accordingly. For example, if network conditions are poor, then the client may throttle down by choosing a lower rate (e.g., lower encode quality level) content. However, this may assume that all content is acquired equally and that a single measurement applies across all transfer options. Consistent with embodiments of the disclosure, throttling may not mean rate-limiting. Rather, the client device may choose a rate that may require a certain amount of throughput, but the transfer may be allowed to run as fast as possible.

With deployment of intermediate devices (e.g., a gateway device, a set top box (STB), a computer) in a local area (e.g., a home, an office, a school) that are capable of caching and options of priming those caches with data from different sources (e.g., satellite push, IP multicast), then the all content acquired equally assumption may no longer hold. For example, if a gateway device in a home can only be partially primed with the highest rate content when playback is started, an ABR algorithm in a client device may see a transfer rate effected by two things: a transfer rate within a local area network (e.g., the home network) from the gateway and a transfer rate across an access connection. In cases where the home network performs much better, the ABR client may likely be served from the cache, but in the event of a cache miss event, the cache miss may “pollute” the results of a transfer rate measurement with apparent drops in network performance. Furthermore, as the drop in performance may only be detected by observing the transfer rate, it may be too late to avoid buffer underrun.

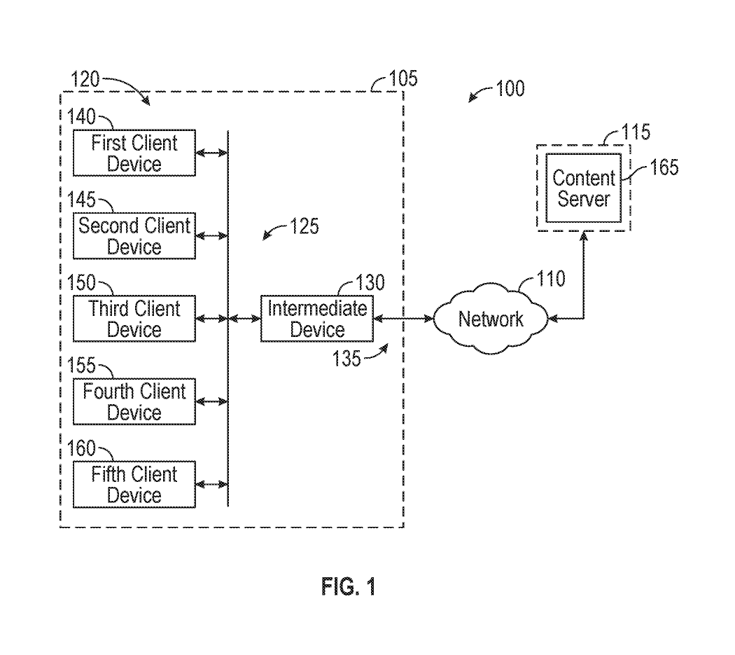

FIG. 1 is a block diagram of a system 100 for providing cache aware streaming. As shown in FIG. 1, system 100 may comprise a local area 105, a network 110, and a content delivery system (CDS) 115. Local area 105 may include a plurality of client devices 120, a local area network 125, an intermediate device 130, and an access connection 135. Plurality of client devices 120 may comprise a first client device 140, a second client device 145, a third client device 150, a fourth client device 155, and a fifth client device 160. CDS 115 may include a content server 165.

Local area 105 may comprise, for example, a home, office, a school, or similar type area. Ones of plurality of client devices 120, may comprise, but are not limited to, a cellular base station, a tablet device, a mobile device, a smart phone, a telephone, a remote control device, a set-top box, a digital video recorder, a cable modem, a personal computer, a network computer, a mainframe, a router, or other similar microcomputer-based device. While FIG. 1 shows five client devices, plurality of client devices 120 may comprise any number of client devices and is not limited to five.

Intermediate device 130 may comprise, for example, a gateway, a set top box (STB), or similar networking or computing device. Intermediate device 130 may have the ability to cache content. Plurality of client devices 120 may connect to intermediate device 130 over local area network 125. Local area network 125 may comprise a wired network or a wireless network (e.g., WiFi). Intermediate device 130 may connect to network 110 over access connection 135. Access connection 135 may be provided by a service provider to allow local area 105 access to network 110. Network 110 may comprise any network that allows CDS 115 to communicate with Intermediate device 130. For example, network 110 may comprise, but is not limited to, the Internet.

CDS 115 may transmit video content to multiple client devices simultaneously. Rather than providing content (e.g., video content) transmission to each of plurality of client devices 120 individually (e.g., unicast transmission), it may be more efficient to broadcast the content to all of plurality of client devices 120 in a common video transmission (e.g., multicast transmission). Content server 165 may provide both a unicast and multicast transmission of content, such as IP video, to plurality of client devices 120. Consistent with embodiments of the disclosure, content server 165 may comprise a separate serving device for each type of transmission. Or content server 165 may comprise a single device capable of providing both unicast and multicast content transmission.

The unicast and multicast transmissions may be communicated over network 110. Network 110 may be compatible with various communication protocols used to communicate unicast and multicast broadcasts. For example, content server 165 may communicate with plurality of client devices 120 over network 110 using a User Datagram Protocol (UDP) or other protocol used to communicate multicast transmissions over IP or non-IP networks such as QAM based content delivery. For various other transmissions, such as unicast transmissions, content server 165 may communicate with plurality of client devices 120 over network 110 using Transmission Control Protocol/Internet Protocol (TCP/IP). CDS 115 may provide both multicast and unicast transmissions of the same content.

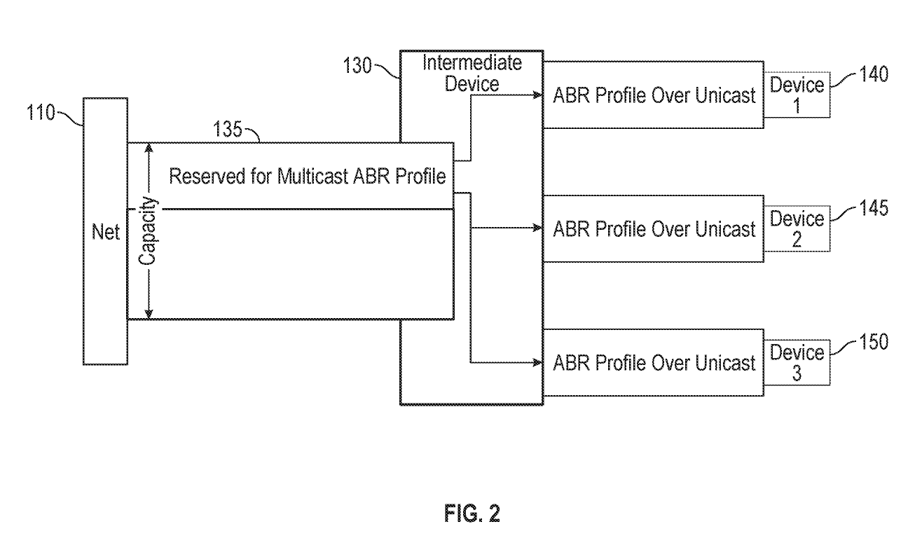

FIG. 2 shows a behavior of system 100 with no competing traffic. As shown in FIG. 2, access connection 135 may be efficiently used with first client device 140, second client device 145, and third client device 150 being served from intermediate device 130 that receives via multicast and caches the content to be consumed. In this case, there may be surplus capacity in access connection 135.

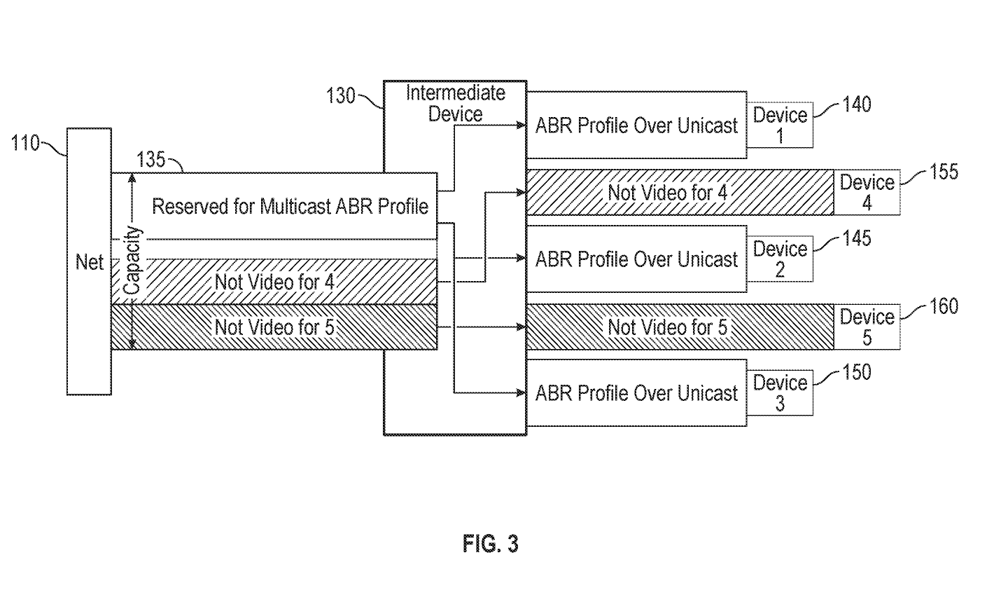

FIG. 3 shows a behavior of system 100 with some competing traffic. As shown in FIG. 3, system 100 may provide effective multicast distribution where first client device 140, second client device 145, and third client device 150 may share the same content despite fourth client device 155 and fifth client device 160 occupying most of capacity of access connection 135 with “not video” (e.g., software down loads). In this example, there is still some surplus capacity in access connection 135.

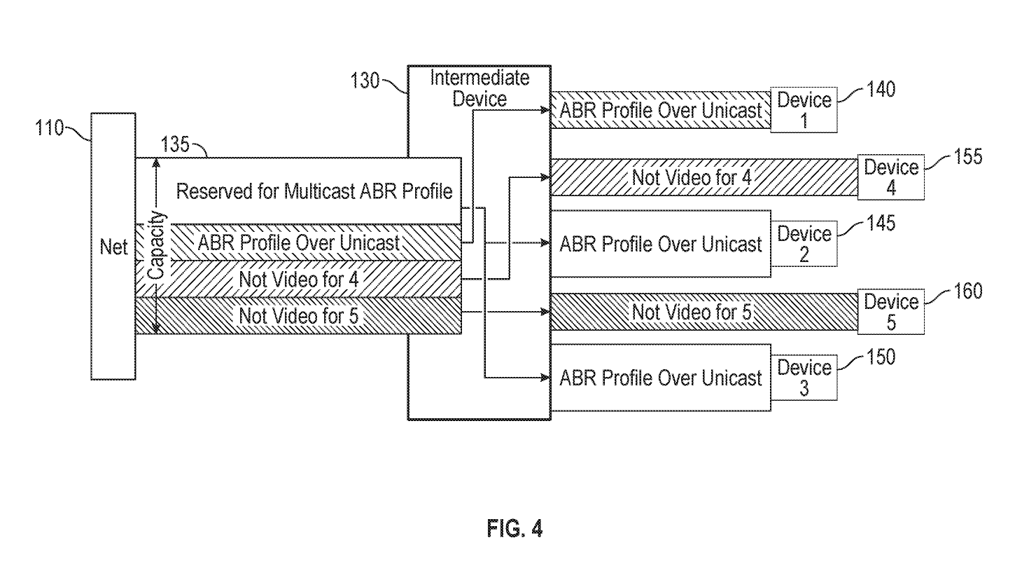

FIG. 4 shows first client device 140 falling back to unicast and choosing a lower profile (e.g., lower encode quality level). First client device 140 may fall back to unicast due to a stall (e.g., a temporary glitch on local area network 125) resulting in first client device 140 falling back to unicast. First client device 140 may fall back to unicast because it may only measure the transfer rate (e.g., throughput) of the unicast flow it sees. Consequently, first client device 140 may throttle down to what is capacity is left in access connection 135, which is less than the throughput required to cause first client device 140 to “want” the higher quality level content available on the multicast cached on intermediate device 130. However, the stall (e.g., glitch on local area network 125) may have only been temporary (e.g., a temporary WiFi problem), so there may presently be plenty of capacity in local area network 125 (e.g., home network). However, first client device 140 may not know this because the bottleneck may be upstream in access connection 135. Accordingly, first client device 140 may have no clue to return to the higher profile that is available in the cache at intermediate device 130 via multicast.

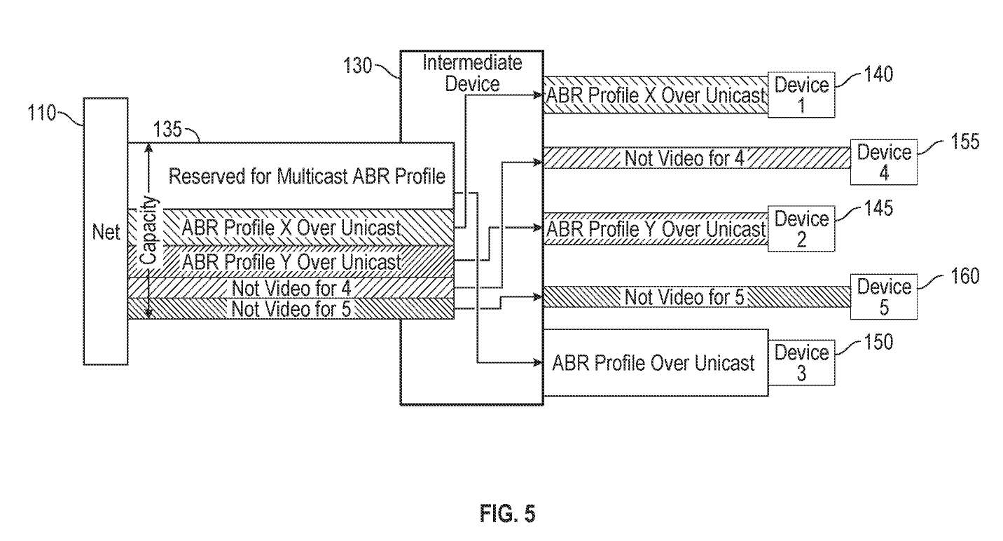

FIG. 5 shows second client device 145 also falling back to unicast. When access connection 135 is fully subscribed, there may be no process for first client device 140 and second client device 145 to return to a higher profile (e.g., higher encode quality level), which result with both staying with the unicast path. For example, second client device 145 may have stalled slightly after first client device 140. Second client device 145 may have chosen a different profile than first client device 140 because it may have measured a different throughput. This now may impact the speed at which first client device 140 may fetch its selection (e.g., further risking underrun). Third client device 150 may now be alone on the multicast path, which may cause intermediate device 130 to decide to terminate this multicast flow, thus further degrading the situation.

Embodiments of the disclosure may cause intermediate device 130 to remains on the same multicast flow and force first client device 140 and second client device 145 back to the multicast flow that is being cached on intermediate device 135. In other words, embodiments of the disclosure may signal to first client device 140 and second client device 145 to switch back to the multicast content once local area network 125 is restored.

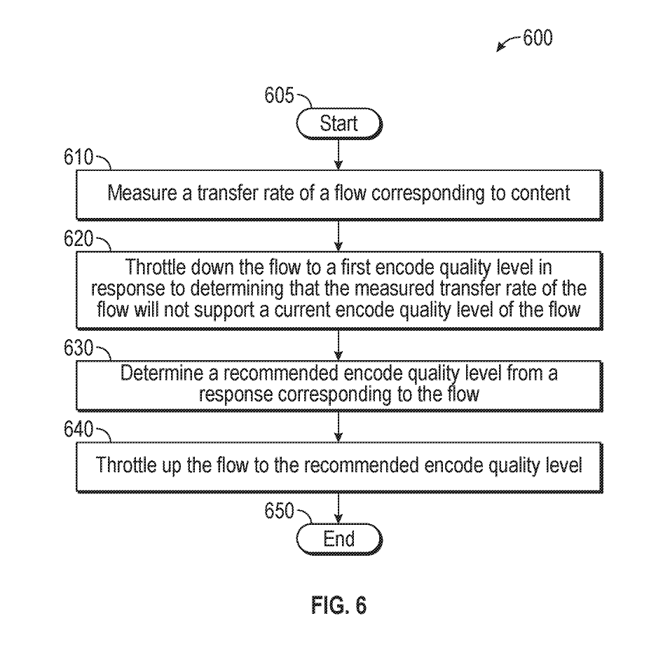

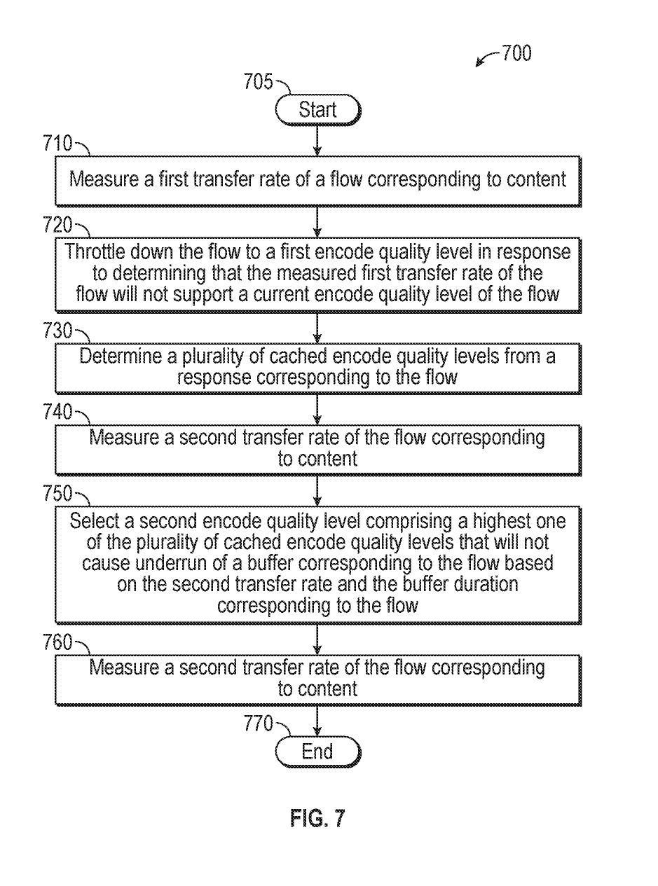

Consistent with embodiments of the disclosure, two respective client-side policies may be described below with respect to FIG. 6 and FIG. 7. FIG. 6 is a flow chart setting forth the general stages involved in a method 600 consistent with an embodiment of the disclosure for providing cache aware streaming. Method 600 may be implemented using first client device 140 as described in more detail below with respect to FIG. 1. Ways to implement the stages of method 600 will be described in greater detail below.

Method 600 may begin at starting block 605 and proceed to stage 610 where first client device 140 may measure a transfer rate of a flow corresponding to content. For example, a stall (e.g., glitch on local area network 125), even if only temporary (e.g., a temporary WiFi problem), may cause first client device 140 to measure a low transfer rate. In other words, conditions on both local area network 125 and access connection 135 may affect the transfer rate measured by first client device 140. In this example, the low measurement may be the result of poor conditions on local area network 125. For example, the transfer rate may comprise the net result of both local area network 125 and access connection 135.

From stage 610, where first client device 140 measures the transfer rate of the flow corresponding to the content, method 600 may advance to stage 620 where first client device 140 may throttle down the flow to a first encode quality level in response to determining that the measured transfer rate of the flow will not support a current encode quality level of the flow. The first encode quality level may be lower than the current encode quality level. For example, first client device 140 may be forced to fall back to the first encode quality level (e.g., first.m3u8 that may require 2 Mb/s of unicast) while intermediate device 130 may be actively acquiring and caching the current encode quality level (e.g., second.m3u8 that may require 4 Mb/s). If the available capacity in access connection 135 is only 3 Mb/s, then first client device 140 may not be able to measure throughput (e.g., transfer rate) sufficient to make first client device 140 want to move back to the current encode quality level that intermediate device 130 is actively acquiring and caching.

Once first client device 140 throttles down the flow to the first encode quality level in stage 620, method 600 may continue to stage 630 where first client device 140 may determine a recommended encode quality level from a response corresponding to the flow. For example, all content requested by the plurality of client devices 108 may be made via HTTP. Intermediate device 130 may intercept each request and either satisfies the request based on intermediate device 130's cache or by forwarding upstream via a unicast path. A list of profiles actively cached on intermediate device 130 may be sent in every response back from intermediate device 130 to the plurality of client devices 108 that relates to a playback session (i.e., segments, init, playlists). Furthermore, a recommended encode quality level may be included in each response corresponding to the flow. The recommended encode quality level may comprise, but is not limited to, the highest encode quality level being cached by intermediate device 135. A profile may refer to any Dynamic Adaptive Streaming over HTTP (DASH) representation or HTTP Live Streaming (HLS) media stream or equivalent. The list may be sent in a HTTP response header. First client device 140 may determine the recommended encode quality level from any of the response headers it receives for example.

After first client device 140 determines the recommended encode quality level from the response corresponding to the flow in stage 630, method 600 may proceed to stage 640 where first client device 140 may throttle up the flow to the recommended encode quality level. Once first client device 140 throttles up the flow to the recommended encode quality level in stage 640, method 600 may then end at stage 650.

FIG. 7 is a flow chart setting forth the general stages involved in a method 700 consistent with another embodiment of the disclosure for providing cache aware streaming. Method 700 may be implemented using first client device 140 as described in more detail below with respect to FIG. 1. Ways to implement the stages of method 700 will be described in greater detail below.

Method 700 may begin at starting block 705 and proceed to stage 710 where first client device 140 may measure a first transfer rate of a flow corresponding to content. For example, a stall (e.g., glitch on local area network 125), even if only temporary (e.g., a temporary WiFi problem), may cause first client device 140 to read a low transfer rate. In other words, conditions on both local area network 125 and access connection 135 may affect the transfer rate measured by first client device 140. In this example, the low measurement may be the result of poor conditions on local area network 125. For example, the first transfer rate may comprise the net result of both local area network 125 and access connection 135.

From stage 710, where first client device 140 measures the first transfer rate of the flow corresponding to content, method 700 may advance to stage 720 where first client device 140 may throttle down the flow to a first encode quality level in response to determining that the measured first transfer rate of the flow will not support a current encode quality level of the flow. The first encode quality level may be lower than the current encode quality level. For example, first client device 140 may be forced to fall back to the first encode quality level (e.g., first.m3u8 that may require 2 Mb/s of unicast) while intermediate device 130 may be actively acquiring and caching the current encode quality level (e.g., second.m3u8 that may require 4 Mb/s). If the available capacity in access connection 135 is only 3 Mb/s, then first client device 140 may not be able to measure throughput (e.g., transfer rate) sufficient to make first client device 140 want to move back to the current encode quality level that intermediate device 130 is actively acquiring and caching.

Once first client device 140 throttles down the flow to the first encode quality level in stage 720, method 700 may continue to stage 730 where first client device 140 may determine a plurality of cached encode quality levels from a response corresponding to the flow. For example, all content requested by the plurality of client devices 108 may be made via HTTP. Intermediate device 130 may intercept each request and either satisfies the request based on intermediate device 130's cache or forwarding upstream via a unicast path. A list of profiles (e.g., plurality of cached encode quality levels) actively cached on intermediate device 130 may be sent in every response back from intermediate device 130 to the plurality of client devices 108 that relates to a playback session (i.e., segments, init, playlists). A profile may refer to any Dynamic Adaptive Streaming over HTTP (DASH) representation or HTTP Live Streaming (HLS) media stream or equivalent. The list may be sent in a HTTP response header. First client device 140 may determine the plurality of cached encode quality levels from any of the response headers for example.

After first client device 140 determines the plurality of cached encode quality levels from the response corresponding to the flow in stage 730, method 700 may proceed to stage 740 where first client device 140 may measure a second transfer rate of the flow corresponding to content. For example, the second transfer rate may comprise the net result of both local area network 125 and access connection 135.

Once first client device 140 measures the second transfer rate of the flow corresponding to content in stage 740, method 700 may continue to stage 750 where first client device 140 may select a second encode quality level comprising a highest one of the plurality of cached encode quality levels that will not cause underrun of a buffer corresponding to the flow based on the second transfer rate and the buffer duration corresponding to the flow. For example, embodiments of the disclosure may look at intermediate device 130's buffer duration and determine whether a profile (e.g., encode quality levels) listed by intermediate devices 130 may be fetched according to the measured throughput (e.g., second transfer rate comprising the net result of both local area network 125 and access connection 135). Continuing the example above, if the segment duration is 5 s and the buffer duration at the time of evaluation is 10 s, then attempting to fetch second encode quality level (e.g., second.m3u8 requiring 4 Mb/s) may succeed without underrun even in the case where local area network 125 may be the bottleneck.

In the process described in FIG. 7, it may be less likely to underrun, but may struggle to jump up to higher profiles if the bottleneck in access connection 135 may be severe and/or the buffer duration may be low. The benefit of the process described in FIG. 6 is that it may be more likely to reach a higher profile, but may risk underrun if the bottleneck is in local area network 125.

After first client device 140 selects the second encode quality level in stage 750, method 700 may proceed to stage 760 where first client device 140 may throttle up the flow to the second encode quality level. Once first client device 140 throttles up the flow to the second encode quality level in stage 760, method 700 may then end at stage 770.

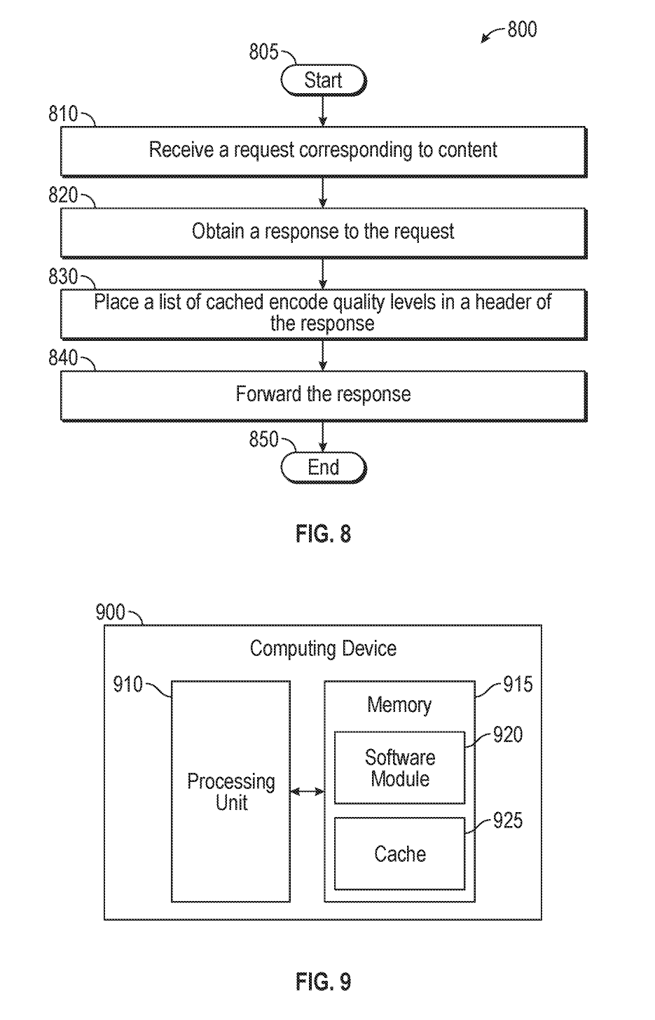

FIG. 8 is a flow chart setting forth the general stages involved in a method 800 consistent with an embodiment of the disclosure for providing cache aware streaming. Method 800 may be implemented using intermediate device 130 as described in more detail below with respect to FIG. 1. Ways to implement the stages of method 800 will be described in greater detail below.

Method 800 may begin at starting block 805 and proceed to stage 810 where intermediate device 130 may receive a request corresponding to content. For example, all content requested by plurality of client devices 120 may be made via HTTP and may be intercepted by intermediate Device 130. In this example, the request corresponding to content may come from first client device 140.

From stage 810, where intermediate device 130 may receive the request corresponding to content, method 800 may advance to stage 820 where intermediate device 130 may obtain a response to the request. For example, intermediate device 130 may intercept each request and either: i) satisfy the request based on intermediate device 130's cache; or ii) forward the request upstream via the unicast path to be satisfied.

Once intermediate device 130 obtains the response to the request in stage 820, method 800 may continue to stage 830 where intermediate device 130 may place a list of cached encode quality levels in a header of the response. For example, a list of actively cached profiles (i.e., encode quality level) may be sent in every response (e.g., HTTP response) back from intermediate device 130 to plurality of client devices 120 that relates to the playback session (i.e., segments, init, playlists). Furthermore, a recommended encode quality level may be included in each response corresponding to the flow. The recommended encode quality level may comprise, but is not limited to, the highest encode quality level being cached by intermediate device 135. A profile, for example, may comprise any DASH representation or HLS media stream or equivalent. The list of actively cached profiles may be sent in a HTTP response header. In the case of HLS, each media stream may be referenced by independent playlists so a list of playlist locations, as found in the master playlist, can be used to unambiguously reference media playlists. For example, the master playlist may comprise:
#EXT-X-STREAM-INF:BANDWIDTH=2000000
first.m3u8
#EXT-X-STREAM-INF:BANDWIDTH=4000000
second.m3u8
   Intermediate device 130 may actively fetch the highest profile via multicast, so intermediate device 130 may specify the following response header (no modification to content itself):
X-AbrCachedGroup: second.m3u8

After intermediate device 130 places the list of cached encode quality levels in the header of the response in stage 830, method 800 may proceed to stage 840 where intermediate device 130 may forward the response. For example, intermediate device 130 may forward the response to first client device 140 from which the request may have come. Once intermediate device 130 forwards the response in stage 840, method 800 may then end at stage 850.

FIG. 9 shows a computing device 900. As shown in FIG. 9, computing device 900 may include a processing unit 910 and a memory unit 915. Memory unit 915 may include a software module 920 and a cache 925. While executing on processing unit 910, software module 920 may perform processes for providing cache aware streaming, including for example, any one or more of the stages from method 600 described above with respect to FIG. 6, method 700 described above with respect to FIG. 7, and method 800 described above with respect to FIG. 8. Computing device 900, for example, may provide an operating environment for any one or more of plurality of client devices 120, intermediate device 130, or content server 165. Plurality of client devices 120, intermediate device 130, or content server 165 may operate in other environments and are not limited to computing device 900.

Computing device 900 may be implemented using a Wi-Fi access point, a cellular base station, a tablet device, a mobile device, a smart phone, a telephone, a remote control device, a set-top box, a digital video recorder, a cable modem, a personal computer, a network computer, a mainframe, a router, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. Furthermore, computing device 900 may comprise, for example, a mobile terminal, such as a smart phone, a cellular telephone, a cellular telephone utilizing Wireless Application Protocol (WAP) or unlicensed mobile access (UMA), personal digital assistant (PDA), intelligent pager, portable computer, a hand-held computer, a conventional telephone, or a Wireless Fidelity (Wi-Fi) access point. The aforementioned systems and devices are examples and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
measuring, by a client device, a transfer rate of a flow corresponding to content;
throttling down, by the client device, the flow to a first encode quality level in response to determining that the measured transfer rate of the flow will not support a current encode quality level of the flow, the first encode quality level being lower than the current encode quality level;
determining, by the client device, a recommended encode quality level from a response corresponding to the flow; and
throttling up, by the client device, the flow to the recommended encode quality level.

2. The method of claim 1, wherein determining the recommended encode quality level from the response comprises determining the recommended encode quality level from the response header.

3. The method of claim 1, wherein determining the recommended encode quality level from the response comprises determining the recommended encode quality level from the response header comprising a Hypertext Transfer Protocol (HTTP) response header.

4. The method of claim 1, wherein measuring the transfer rate of the flow comprises measuring the transfer rate of the flow within a local area network from an intermediate device and across an access connection.

5. The method of claim 1, further comprising requesting, by the client device, the content.

6. An apparatus comprising:
a memory storage; and
a processing unit coupled to the memory storage, the processing unit being configured to:
measure a first transfer rate of a flow corresponding to content;
throttle down the flow to a first encode quality level in response to determining that the measured first transfer rate of the flow will not support a current encode quality level of the flow, the first encode quality level being lower than the current encode quality level;
determine a plurality of cached encode quality levels from a response corresponding to the flow;
measure a second transfer rate of the flow corresponding to content;
select a second encode quality level comprising a highest one of the plurality of cached encode quality levels that will not cause underrun of a buffer corresponding to the flow based on the second transfer rate and the buffer duration corresponding to the flow; and
throttle up the flow to the second encode quality level.

7. The apparatus of claim 6, wherein the processing unit being configured to determine the plurality of cached encode quality levels from the response comprises the processing unit being configured to determine the plurality of cached encode quality levels from the response header.

8. The apparatus of claim 6, wherein the processing unit being configured to determine the plurality of cached encode quality levels from the response comprises the processing unit being configured to determine the plurality of cached encode quality levels from the response header comprising a Hypertext Transfer Protocol (HTTP) response header.

9. The apparatus of claim 6, wherein the processing unit being configured to measure the first transfer rate of the flow comprises the processing unit being configured to measure the first transfer rate of the flow within a local area network from an intermediate device and across an access connection.

10. The apparatus of claim 6, further comprising the processing unit being configured to request the content.

11. A method comprising:
receiving, at an intermediate device, a request corresponding to content;
obtaining, by the intermediate device, a response to the request;
placing, by the intermediate device, a list of cached encode quality levels in a header of the response; and
forwarding, by the intermediate device, the response.

12. The method of claim 11, wherein obtaining the response to the request comprises obtaining the response to the request from a cache.

13. The method of claim 11, wherein obtaining the response to the request comprises obtaining the response to the request from a cache on the intermediate device.

14. The method of claim 11, wherein obtaining the response to the request comprises obtaining the response to the request from an upstream unicast path.

15. The method of claim 11, wherein receiving, at the intermediate device, the request comprises receiving, at the intermediate device, the request wherein the intermediate device comprises a gateway.

16. The method of claim 11, wherein placing the list of the cached encode quality levels in the header of the response comprises placing the list of the cached encode quality levels in the header of the response comprising a Hypertext Transfer Protocol (HTTP) response header.

17. The method of claim 11, wherein receiving the request corresponding to content comprises receiving the request over a wireless local area network.

18. The method of claim 11, wherein forwarding the response comprises forwarding the response over a wireless local area network.

19. The method of claim 11, wherein receiving the request corresponding to content comprises receiving the request from a client device.

20. The method of claim 11, wherein forwarding the response comprises forwarding the response to a client device.
